(19) United States
(12) Patent Application Publication
(10) Pub. No.: US 2026/0252897 A1
(43) Pub. Date: Aug. 27, 2026

(54) REINFORCEMENT LEARNING USING DENSITY ESTIMATION WITH ONLINE CLUSTERING FOR EXPLORATION

(71) Applicant: DeepMind Technologies Limited, London (GB)

(72) Inventors: Alaa Saade, Montreuil (FR); Steven James Kapturowski, St. Albans (GB); Daniele Calandriello, Paris (FR); Charles Blundell, London (GB); Michal Valko, Paris (FR); Pablo Sprechmann, London (GB); Bilal Piot, London (GB)

(21) Appl. No.: 18/872,611

(22) PCT Filed: Sep. 28, 2023
(86) PCT No.: PCT/EP2023/076893

§ 371 Date: Dec. 6, 2024

Related U.S. Application Data
(60) Provisional application No. 63/410,966, filed on Sep. 28, 2022.

(51) Int. Cl. G06N 3/092; G06F 18/22; G06N 3/045

(52) U.S. Cl. CPC G06N 3/092; G06F 18/22; G06N 3/045

(57) ABSTRACT

Methods, systems, and apparatus, including computer programs encoded on computer storage media, for training a neural network used to select actions to be performed by an agent interacting with an environment. Implementations of the described techniques can learn to explore the environment efficiently by storing and updating state embedding cluster centers based on observations characterizing states of the environment.

### CROSS-REFERENCE TO RELATED APPLICATION

This application claims priority to U.S. Provisional Application No. 63/410,966, filed on Sep. 28, 2022. The disclosure of the prior application is considered part of and is incorporated by reference in the disclosure of this application.

### BACKGROUND

This specification relates to machine learning, in particular reinforcement learning.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

In a reinforcement learning system an agent interacts with an environment, e.g., a real-world environment, by performing actions that are selected by the reinforcement learning system in response to receiving successive “observations”, i.e. datasets that characterize the state of at least part of the environment at corresponding time-steps, e.g., the outputs of sensor(s) which sense at least part of the real world environment at those time-steps.

### SUMMARY

This specification describes a system, implemented as computer programs on one or more computers in one or more locations, for controlling an agent that is interacting with an environment. More particularly, implementations of the system help the agent to explore new states of the environment. Implementations of the system are adapted for parallel operation.

In one aspect there is described a method, and a corresponding system, implemented by one or more computers, for training a computer-implemented neural network system used to control an agent interacting with an environment, e.g. to perform a task. The system includes an action selection neural network system used to select actions to be performed by the agent, a representation generation neural network system configured to process an observation of a state of the environment to generate a state embedding, and memory.

The method involves, at a plurality of time steps: obtaining a current observation characterizing a current state of the environment, processing the current observation using the action selection neural network system to select an action to be performed by the agent at the time step, obtaining a subsequent observation characterizing a subsequent state of the environment after the agent performs the selected action, and processing the subsequent observation using the representation generation neural network system to generate a subsequent state embedding representing at least the subsequent observation. An update step is performed on data stored in the memory using the subsequent state embedding.

In the memory is maintained a record of previously visited regions of a state space of the environment as data comprising state embedding cluster centers representing centers of the previously visited regions in a space of the state embeddings. For each state embedding cluster center there is a corresponding count value representing a visitation count of the corresponding region of state space of the environment by the agent. An intrinsic reward is generated using the state embedding cluster center and corresponding count value data stored in the memory, to reward exploration of states of the environment by the agent. The action selection neural network system is trained based on a reward including the intrinsic reward.

In implementations performing the update step comprises updating or replacing one or more of the state embedding cluster centers and one or more of the corresponding count values using the subsequent state embedding.

Another method involves training a representation generation neural network system to generate a respective training state embedding by processing each of the training observations in a sequence of time steps, using a representation generation neural network system, to generate a respective training state embedding for each of the training observations in the sequence; processing each of the training state embeddings, and each of the actual actions in the sequence except a final actual action, using an action prediction neural network system, to generate an action prediction output; and training the representation generation neural network system based on the action prediction output and the final actual action.

The subject matter described in this specification can be implemented in particular embodiments so as to realize one or more of the following advantages.

Exploration in reinforcement learning is a difficult but important task. Some approaches to exploration count the number of times a particular state of the environment is visited, but this is intractable with large or continuous state spaces. One way to address this is to estimate visitation counts using a neural network, but these methods can be inaccurate. Another way to address this is to use a slot-based memory to store representations of encountered states, but these approaches suffer from limitations arising from the finite amount of memory available and tend to operate on relatively short-term time scales. The techniques described herein can operate effectively in large or continuous state spaces over long time scales.

Some implementations of the described system can be used in difficult environments where (task) rewards are sparse and long sequences of actions need to be executed before receiving a reward, e.g. complex 3D manipulation or navigation tasks. In implementations of the system the (episodic) memory never needs to be reset, which allows learning to occur continuously over long timescales. Some implementations of the system also have improved robustness to the present of noise or distracting features in the environment.

Implementations of the system are adapted to a parallel, distributed implementation because the way in which observations of the environment are collected and represented in the memory allows the memory to be shared between multiple actors.

The described techniques can be used in a wide range of different reinforcement learning systems and are not limited to any particular reinforcement learning approach. They are flexible and can be implemented in the context of existing systems to improve them.

Some techniques are described that provide state embeddings that encode states of the environment in a way that is useful for the described approaches to exploration, but that can also be used independently of these.

Some implementations of the system can learn tasks that other systems find difficult or impossible; some implementations can learn tasks faster, and consuming less computational resources, than other systems.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example of a computer-implemented reinforcement learning neural network system.

FIG. 2 is a flow diagram of an example process for training a reinforcement learning system.

FIG. 3 is a flow diagram of an example process for performing an update step on data stored in memory.

FIG. 4 is a flow diagram of an example process for training a representation generation neural network system.

FIG. 5 shows an example action prediction neural network system.

FIG. 6 shows an example of a reinforcement learning neural network system implemented in a parallel distributed computing system.

FIG. 7 illustrates the performance of an example implementation of the computer-implemented reinforcement learning neural network system of FIG. 1.

Like reference numbers and designations in the various drawings indicate like elements.

### DETAILED DESCRIPTION

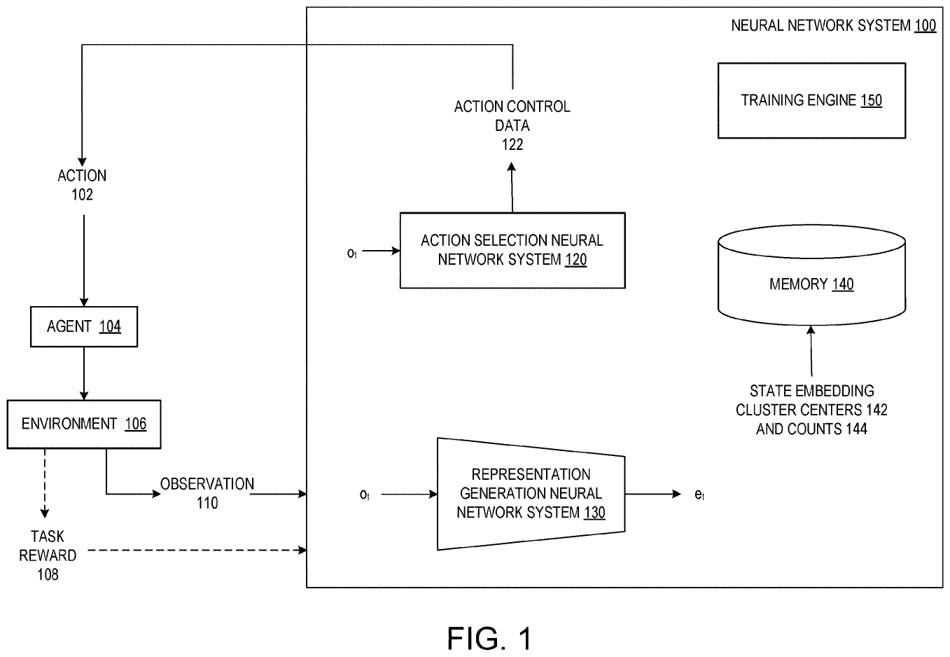

FIG. 1 is a block diagram of an example of a computer-implemented neural network system 100, e.g. a reinforcement learning neural network system, that may be implemented as one or more computer programs on one or more computers in one or more locations. The computer-implemented neural network system 100 is used to control an agent 104 interacting with an environment 106 to select actions 102 to be performed by the agent, to explore the environment or to perform a task. Implementations of the described system are good at exploring the environment 106, which helps them to learn to control the agent 104 to perform difficult tasks. For illustrative purposes a few of the tasks that the computer neural network system 100 can perform are described later.

The neural network system 100 includes an action selection neural network system 120, used to select the actions 102 to be performed by the agent. In general the action selection system neural network comprises an action selection neural network having learnable action selection neural network parameters, e.g. weights.

Such an action selection neural network, and in general each of the neural networks described herein, can have any suitable architecture and may include, e.g., one or more feed forward neural network layers, one or more convolutional neural network layers, one or more attention neural network layers, or one or more normalization layers. In some implementations a neural network as described herein may be distributed over multiple computers.

The neural network system 100 obtains an observation 110, oₜ, of the environment 106 at each of a succession of time steps. In general the observation 110, oₜ, may comprise any data characterizing a current state of the environment, e.g., an image of the environment. In some implementations the observation at a time step can include a representation of a history of observations at one or more previous time steps.

The action selection neural network system 120 is configured to process a current observation, oₜ, 110, in accordance with the action selection neural network parameters, to generate action control data 122 for selecting the action 102 to be performed by the agent 104. For example, the system can instruct the agent and the agent can perform the selected action. As another example, the system can directly generate control signals for one or more controllable elements of the agent. As yet another example, the system can transmit data specifying the selected action to a control system of the agent, which controls the agent to perform the action. Generally, the agent performing the selected action results in the environment transitioning into a different state.

There are many ways in which the action control data 122 can be used to select actions. For example it can (directly) identify an action to be performed, e.g. by identifying a speed or torque for a mechanical action. As another example it can parameterize a distribution over possible actions, e.g. a categorical or continuous distribution, from which the action to be performed can be chosen or sampled. In general an action 102 may be continuous or discrete. The “action” 102 may comprise multiple individual actions to be performed at a time step e.g. a mixture of continuous and discrete actions. In some implementations the action selection neural network system 120 can multiple heads, and the action selection output 122 may comprise multiple outputs for selecting multiple actions at a particular time step.

The action selection neural network system 120 is trained using the observations 110 and based on rewards received, under the control of a training engine 150. In general a reward comprises a (scalar) numerical value, and may be positive, negative, or zero. The neural network system 100 generates an intrinsic reward, rᵢ, used to drive exploration of the environment 106. In some cases the neural network system 100 also receives a task-related reward 108 from the environment 106 that characterizes progress made on a task performed by the agent 104, e.g. representing completion of a task or progress towards completion of the task as a result of the agent performing a selected action.

During training the neural network system 100 also includes a representation generation neural network system 130, configured to process an observation 110 of a state of the environment, in accordance with representation generation neural network parameters, e.g. weights, to generate a state embedding, eₜ. As used herein an “embedding” of an entity can refer to a representation of the entity as an ordered collection of numerical values, e.g., a vector or matrix of numerical values. The representation generation neural network system 130 can have any suitable architecture, as previously described, e.g. a feed-forward network architecture.

One of the advantages of the described techniques is that they are not dependent on the use of any particular type of state (observation) embedding or representation generation neural network system 130. Nonetheless this specification also describes techniques for generating state embeddings that are useful for long-term state novelty estimation, and that are particularly helpful when used with the neural network system 100.

In implementations the neural network system 100 also includes a memory 140, that may be referred to as an episodic memory because it stores representations of previously visited regions in a space of the state embeddings. More particularly, in implementations the memory 140 is configured to store, in each of a plurality of M indexed locations or “slots”, a record, i.e. data, comprising a state embedding cluster center 142, f (generally a vector), and a corresponding count value 144, c (generally a scalar). Merely as an example, in some implementations the memory 140 may store of order 104 to 106 state embedding cluster centers, depending on the application.

Generally, as used herein a state embedding cluster center is a state embedding that defines the center of a state embedding region that represents a region of environment state space, in particular the center of a previously visited region in the space of the state embeddings.

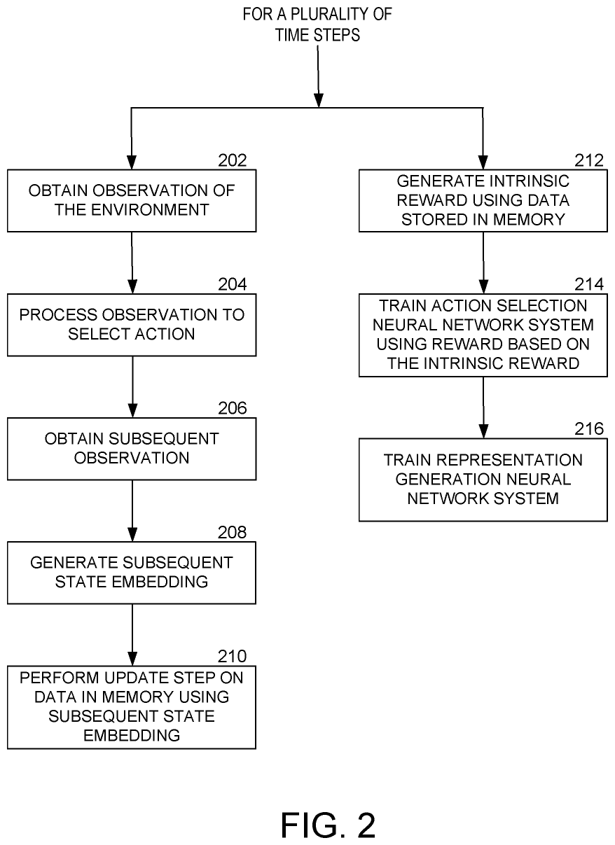

FIG. 2 is a flow diagram of an example process for training a reinforcement learning system, such as the neural network system 100 of FIG. 1. The process of FIG. 2 may be implemented by one or more computers in one or more locations, e.g. by the training engine 150. In implementations, and as illustrated in FIG. 2 and later, aspects of the process may be performed in parallel with one another.

In implementations the process involves, at a plurality of time steps, obtaining a current observation characterizing a current state of the environment (step 202). The current observation is processed using the action selection neural network system 120, in particular in accordance with the action selection neural network parameters, to select an action to be performed by the agent at the time step (step 204).

The process then obtains a subsequent observation characterizing a subsequent state of the environment after the agent performs the selected action (step 206). The subsequent observation is processed using the representation generation neural network system 130 to generate a subsequent state embedding, eₜ₊₁, representing at least the subsequent observation (step 208). In some implementations the subsequent state embedding may also represent (some of) a history of the observations. In general these steps are performed at each of the plurality of time steps.

In implementations the process can include maintaining a record of previously visited regions of a state space of the environment in the memory 140. The record can be maintained as data comprising state embedding cluster centers representing centers of the previously visited regions in a space of the state embeddings. The process can also include maintaining, for each state embedding cluster center, a corresponding count value. In implementations the count value represents a visitation count of the corresponding region of state space of the environment by the agent, i.e. a count value for the region in the space of the state embeddings. The visitation count may comprise a representation of how many times the agent has visited that region of state space of the environment.

The process performs an update step on the data stored in the memory using the subsequent state embedding (step 210). In some implementations, e.g. in a distributed system, this can be performed in parallel with steps 202-208. In general the update is performed at each of the plurality of time steps.

In implementations performing the update step on the data stored in the episodic memory using the subsequent state embedding comprises updating or replacing one or more of the state embedding cluster centers and one or more of the corresponding count values using the subsequent state embedding.

In a particular implementation, performing the update step comprises determining whether to perform an update or to perform a replacement of one or more of the existing state embedding cluster centers stored in the memory 140. The determination can be based on a distance of the subsequent state embedding from a nearest existing state embedding cluster center. When the subsequent state embedding is within a threshold distance of the nearest existing state embedding cluster center, the nearest existing state embedding cluster center, and the corresponding count value, are both updated. When the subsequent state embedding is beyond a threshold distance from the nearest existing state embedding cluster center the nearest existing state embedding cluster center is replaced (and the corresponding count value is (re)initialized).

The process generates an intrinsic reward, using the data stored in the memory 140 (step 212), in particular using the using the cluster center and count value data stored in the episodic memory. In general the intrinsic reward rewards exploration of states of the environment by the agent. An example of generating the intrinsic reward is described below; this may be performed at the same or different ones of the time steps to the action selection and memory update, depending upon the implementation.

In implementations the action selection neural network system 120 is trained based on a reward, i.e. an overall reward, including the intrinsic reward (step 214). This can comprise updating values of the action selection neural network parameters based on the reward including the intrinsic reward.

In general the action selection neural network system 120 is trained using a reinforcement learning technique, i.e. dependent on the value of a reinforcement learning objective function, by backpropagating gradients of the reinforcement learning objective function to update values of the learnable action selection neural network parameters. This may use any appropriate gradient descent optimization algorithm, e.g. Adam or another optimization algorithm. Any appropriate reinforcement learning objective function may be used; merely as examples the reinforcement learning objective function may determine a Be∥man error, or may use a policy gradient, based on the reward.

The techniques described herein can be used with any type of reinforcement learning, e.g. on-policy or off-policy, model-based or model-free, based on Q-learning or using a policy gradient approach, optionally in an actor-critic system (in which the critic learns a value function). The reinforcement learning system may, but need not be, distributed; the reinforcement learning may be performed online or offline.

The action selection neural network 120 may be, or may be trained as, part of a larger action selection system. For example such a larger action selection system may be part of an actor-critic system that includes a critic neural network as we∥as the action selection neural network; or it may be part of a system that uses a model to plan ahead e.g. based on simulations of the future; or it may be a system comprising one or more learner action selection neural networks and one or more actor action selection neural networks e.g. distributed over one or more computing devices.

At step 216 the training process can also train the representation generation neural network system 130, separately or jointly with (at the same time as) the action selection neural network system 120, e.g. using the training engine 150. Alternatively the representation generation neural network system 130 may have been pre-trained. There are many ways in which representation generation neural network system 130 can be trained. As one example, it may be trained using an auto-encoding loss. A technique that is particularly useful for training the representation generation neural network system 130 for use in the system 100 is described later.

Some implementations of the above described method keep the memory size fixed. In effect the total number of state embedding cluster centers is stochastically projected down onto an upper limit on the number of clusters (otherwise they could grow without bound, albeit progressively more slowly). Also in implementations each subsequent state embedding is incorporated into the memory, i.e. into a state embedding cluster centers stored in the memory, once and then discarded. Thus implementations of the above described method facilitate maintaining a constant space complexity when processing a continuous stream of incoming data (observations).

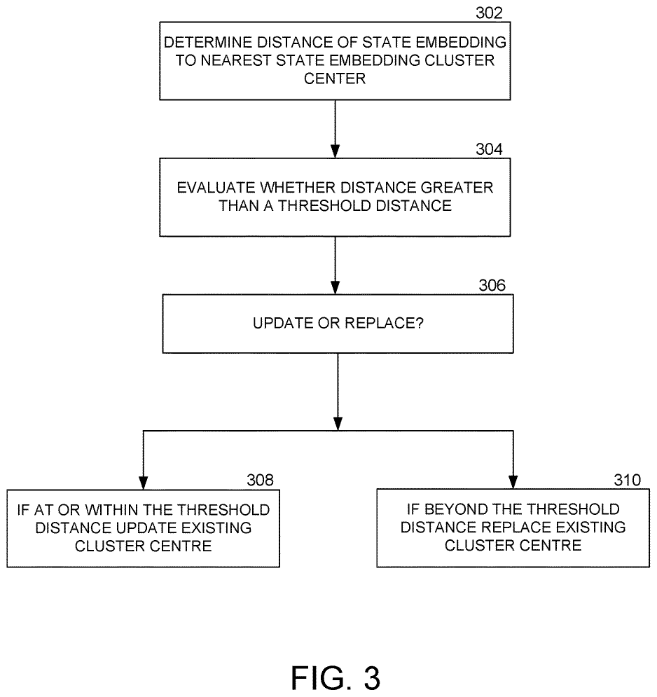

FIG. 3 is a flow diagram of an example process for performing an update step on data stored in the memory 140 using the subsequent state embedding. The process of FIG. 3 may be implemented by one or more computers in one or more locations, e.g. by the training engine 150.

The example process of FIG. 3 can involve (at each of the plurality of time steps) determining a distance between an embedding, e, in particular the subsequent state embedding, eₜ₊₁, and a nearest one of the state embedding cluster centers stored in the memory 140, fᵢ(step 302), where the memory 140 stores M cluster centers, f_{1 . . . M}.

In implementations the distance between the subsequent state embedding and the nearest one of the state embedding cluster centers stored in the memory is determined according to a distance metric, e.g. a Euclidean distance metric, e.g. as

$${‖ {f}_{i} - e ‖}_{2}^{2}$$

where ∥·∥² denotes a 2-norm.

The process can involve evaluating whether the distance (determined according to the distance metric) between the subsequent state embedding and the nearest one of the state embedding cluster centers stored in the episodic memory is greater than a threshold distance (step 304).

For example the process can determine whether the distance satisfies a distance condition, where the distance condition is satisfied when the distance is greater than the threshold distance from the nearest one of the state embedding cluster centers. The distance condition may be that

$${‖ {f}_{i} - e ‖}_{2}^{2}$$

is greater than

$$κ {d}_{m}^{2}$$

where

$$κ {d}_{m}^{2}$$

defines a (squared) threshold distance. In implementations dₘ is a distance parameter that can be based, e.g., on an exponentially-weighted moving average of distances between the embeddings; and k is a tolerance parameter (which may be 1). More particularly

$${d}_{m}^{2}$$

distance between an embedding and its nearest neighbors in the memory 140.

In some implementations the threshold distance is updated using the subsequent state embedding, e.g. by updating the parameter

$${d}_{m}^{2} ,$$

in implementations prior to making the determination of whether the distance satisfies the distance condition. This may comprise updating the threshold distance based on the distance between the subsequent state embedding and at least the nearest one of the state embedding cluster centers stored in the memory 140, e.g. by updating a moving average of the threshold distance. Such a moving average may be determined from the threshold distance, and one or more distances between the subsequent state embedding and one or more respective nearest neighbor state embedding cluster centers.

Updating the threshold distance using the subsequent state embedding can facilitate the system to adapting to the environment. For example, in some applications the distance between embedded observations can vary considerably throughout the course of training, e.g. as a result of non-stationarity in the action selection policy of the action selection neural network system 120, and potentially also as a result of non-stationarity in the embedding function implemented by the representation generation neural network system 130. Updating the threshold distance as described can mitigate the effects of this.

As one particular example, dₘ can be based on an exponentially-weighted moving average of distances between the embeddings, e.g. based on a mean squared distance of the subsequent state embedding, e, to one or more of the nearest cluster centers, e.g. those for which

$${‖ f - e ‖}_{2}^{2} < {d}_{m}^{2} .$$

For example the distance parameter, dₘ, may be determined as

$${d}_{m}^{2} ← ( 1 - τ ) {d}_{m}^{2} + \frac{τ}{k} {\sum }_{f ∈ {N}_{k} ( e )} {‖ f - e ‖}_{2}^{2}$$

where τ is a decay rate parameter, k is a number of nearest neighbor cluster centers of e, e.g. neighbors for which

$${‖ f - e ‖}_{2}^{2} ,$$

and f∈Nₖ(e) denotes those nearest neighbor cluster centers (in this example all the cluster centers within a

$${d}_{m}^{2}$$

ball, rather than a fixed number of k nearest neighbors).

The process determines whether to perform an update of one or more existing state embedding cluster centers stored in the memory 140 or whether to replace one or more existing state embedding cluster centers stored in the memory 140 (step 306). In implementations the decision is based on the distance of the subsequent state embedding from the nearest existing state embedding cluster center, e.g. based on whether the distance condition is satisfied. For example as previously described the process may determine whether

$${‖ {f}_{i} - e ‖}_{2}^{2}$$

is greater than

$$κ {d}_{m}^{2} .$$

In some implementations the decision as to whether to (remove and) replace a state embedding cluster center if the threshold distance criterion is met, or whether to update an existing state embedding cluster center, is made stochastically. For example the selecting of a state embedding cluster center to remove and replace may be may be performed subject to a selection probability (insertion probability), n, that determines whether or not the decision to remove and replace is taken if the threshold distance criterion is met. As one example, this can involve sampling a real number, u, in the range 0 to 1 from a uniform distribution. The decision as to whether to (remove and) replace a state embedding cluster center can then depend on whether both

$${‖ {f}_{i} - e ‖}_{2}^{2} > κ {d}_{m}^{2}$$

and u<η. In implementations, if the decision is not to replace an existing state embedding cluster center then the process instead updates an existing state embedding cluster center.

Adding stochasticity to the decision can increase the stability of the process to noise. In particular, an embedding that is beyond the threshold distance will be added to the memory after it is seen on average 1/η times, making one-off outliers less of a problem. At the same time, if a distant embedding is observed multiple times, and hence becomes relevant for the (soft-visitation) count values, there is a high chance that it will be added to the memory (and to keep memory size constant an existing state embedding cluster center can be removed).

When the subsequent state embedding is at or within the threshold distance of the nearest existing state embedding cluster center the process updates the nearest existing state embedding cluster center and the corresponding count value (step 308).

When the subsequent state embedding is beyond the threshold distance of the nearest existing state embedding cluster center the process can select an existing state embedding cluster center to replace (step 310), e.g. an underpopulated existing state embedding cluster center. As previously described, determining whether to replace the nearest existing state embedding cluster center may be stochastic, i.e. in implementations the process replaces the nearest existing state embedding cluster center with a probability η.

Which existing state embedding cluster is replaced may also be determined stochastically. For example an underpopulated existing state embedding cluster center may be selected stochastically based on its corresponding count value, e.g. with a probability of selection that increases as its corresponding count value decreases. As a particular example, an underpopulated existing state embedding cluster center may be selected with a probability that is inversely proportional to the square of its corresponding count value.

Thus when the decision is to remove and replace a state embedding cluster center in the memory 140, the particular state embedding cluster center to remove can be chosen stochastically. This can involve selecting, e.g. stochastically, one of the indexed locations as the indexed location of a state embedding cluster center to remove from the memory 140, and selecting the corresponding count value.

As previously described, in implementations the indexed location of the state embedding cluster center to remove from the episodic memory and the corresponding count value are selected conditional upon, i.e. in response to, the distance condition being satisfied. The state embedding cluster center at the indexed location in the episodic memory is replaced with the subsequent state embedding.

Optionally, the selected corresponding count value (for the removed state embedding cluster center) can be redistributed over one or more other indexed locations in the memory 140, to update the count at those locations. For example, this may comprise adding the selected corresponding count value to the count value of the nearest one (according to the distance metric) of the state embedding cluster centers to the replaced state embedding cluster center in the memory 140. Alternatively the selected corresponding count value can be removed completely. Experimentally, redistributing the selected corresponding count value appears to be a more robust approach than completely removing the corresponding count value. The corresponding count value for the replaced state embedding cluster center can be initialized to an initial value, e.g. 1.

In some implementations the indexed location of the state embedding cluster center to remove is selected according to the corresponding count of the state embedding cluster center, with a bias towards selecting an indexed location with a relatively lower corresponding count value from amongst the count values for the memory locations (state embedding cluster centers). For example the indexed location of a state embedding cluster center to remove may be determined as one with a smallest corresponding count value.

When the selection of a particular indexed location is stochastic the selection of a particular indexed location may, e.g., comprise stochastically sampling the indexed location of a state embedding cluster center to remove according to a probability that depends inversely on the corresponding count value, e.g. as 1/c or 1/c² where c is the count value.

In general these strategies have the effect of selecting a state embedding cluster center to remove that is relatively underexplored (underpopulated), whilst retaining relatively more explored locations for later use in determining where has previously been explored. Experimentally the technique appears robust as to which particular strategy for replacing an underpopulated state embedding cluster center is used.

As previously described, when the distance between the subsequent state embedding and the nearest one of the state embedding cluster centers is not greater than the threshold distance, performing the update step on the data stored in the memory 140 may comprise updating the state embedding cluster center at the nearest one of the state embedding cluster centers using the subsequent state embedding, and updating the corresponding count value, e.g. by incrementing the corresponding count value. When the distance is greater than the threshold distance but the state embedding cluster center is not replaced (e.g. because the decision is made stochastically), the state embedding cluster center and corresponding count value may also be updated in this way.

Updating the nearest state embedding cluster center, fᵢ, may comprise determining an updated value of the nearest state embedding cluster center as a linear (convex) combination of a current value of the state embedding cluster center weighted by the corresponding count value for the nearest state embedding cluster center, cᵢ, and the subsequent state embedding, e. For example updating state embedding cluster center may comprise updating fᵢ as:

$${f}_{i} ← \frac{{c}_{i}}{{c}_{i} + 1} {f}_{i} + \frac{1}{{c}_{i} + 1} e$$

The corresponding count value for the nearest state embedding cluster center may be incremented by one.

In implementations the intrinsic reward is generally based on an inverse of the corresponding count value for one or more state embedding cluster centers near the subsequent state embedding. For example, a high count value for a nearby stored cluster center then results in a low intrinsic reward. In this way the intrinsic reward, e.g. a numerical value, can indicate a degree of novelty of the subsequent state of the environment, e.g. a degree to which that state is different from, or similar to, one that has been encountered before. A relatively higher intrinsic reward indicates greater novelty, and hence desirability for exploration; and vice-versa.

For example, if the agent is a mechanical agent in a real-world environment the states of the environment can represent physical states or configurations of the environment and/or of the agent in the environment, e.g. a configuration of a robot arm or the location of an agent navigating in the environment. The intrinsic reward can have a small e.g. positive value if the agent moves to a state of the environment that is similar to one that has been encountered before, and a larger value if the agent moves to a state of the environment that is relatively unlike those encountered before.

Generating the intrinsic reward can involve determining a measure of a similarity between the subsequent state embedding and one or more of the state embedding cluster centers stored in the memory 140 (the measure increasing with greater similarity). The intrinsic reward may be determined as a value that depends inversely on the measure of the similarity and inversely on the corresponding count values for the one or more state embedding cluster centers. In general the intrinsic reward can be any decreasing function of the count values of the state embedding cluster centers.

As an example, generating the intrinsic reward may comprise determining a soft visitation count for the subsequent state embedding from a combination, e.g. sum, of count values weighted by kernel functions. Each kernel function, [symbol] (f, e), may depend on or define a similarity between the subsequent state embedding, e, and a respective one of the state embedding cluster centers, f. A visitation count, [symbol] , may be determined as

$${N}_{𝒦} = {\sum }_{l = 1}^{M} 𝒦 ( {f}_{l} , e ) .$$

Such a visitation count may be called a “soft” visitation count because its value need not be quantized at the count update values. Each kernel function may be weighted by a corresponding count value for the respective one of the state embedding cluster centers in the combination. Thus in some implementations the soft visitation count is determined as

$${N}_{𝒦} = {\sum }_{l = 1}^{M} {w}_{l} 𝒦 ( {f}_{l} , e )$$

where wₗ is a weight that depends on the corresponding count value for state embedding cluster center fₗ, e.g. as wₗ=1+cₗ. Such a soft visitation count captures not only visits to a particular part of the state space of the environment, but also visits close to this part of the state space (according to the embedding function).

Various kernel functions may be used, e.g. a Gaussian kernel function such as

$$𝒦 ( f , e ) = exp ( - {‖ e - f ‖}_{2}^{2} ) ,$$

or an inverse kernel function such as

$$𝒦 ( f , e ) = \frac{1}{1 + {‖ e - f ‖}_{2}^{2}} .$$

In some implementations

$$𝒦 ( f , e ) = \frac{ϵ}{ϵ + \frac{{‖ e - f ‖}_{2}^{2}}{{d}_{m}^{2}}} {\text{?}}_{\{ {‖ e - f ‖}_{2}^{2} < {d}_{m}^{2} \}}$$

where ∈ is a fixed (positive real) parameter, and

$${\text{?}}_{\{ {‖ e - f ‖}_{2}^{2} < {d}_{m}^{2} \}}$$

is the indicator function, that in this example defines all the state embedding cluster center neighbors within a

$${d}_{m}^{2}$$

ball from e. Summing over all the neighbors within a particular distance (dₘ) rather than, e.g., selecting a fixed number of k-nearest neighbors can inhibit undesired behavior under some circumstances. For example performing an update step on data stored in the episodic memory could change a k-nearest neighbor list so as to reduce rather than increase the soft visitation count of a subsequent state embedding (by displacing a cluster center with a large count).

The intrinsic reward may be determined as an intrinsic reward function of the soft visitation count. Generally the intrinsic reward function has a value that decreases as the soft visitation count increases, e.g. as an inverse square root of the soft visitation count. For example the intrinsic reward, rᵢ, may be determined as

$$\frac{1}{\sqrt{{N}_{𝒦}}} .$$

Optionally a small constant may be added to [symbol] for numerical stability, e.g. as

$${r}_{i} = {( \sqrt{{N}_{𝒦}} + constant )}^{- 1} ;$$

optionally rᵢ may be normalized by a running estimate of its standard deviation.

In some implementations performing the update step can include decaying each of the corresponding count values stored in the memory 140. This may be done by multiplying each of these by a discount factor, e.g. so that cᵢ←γcᵢ where γ<1 is a decay constant or “discount”; as examples, γ≥0.9 or 0.99 or 0.999. This may be done prior to making the determination of whether to remove/replace a state embedding cluster center in the episodic memory or update a corresponding count value.

Decaying the corresponding count values can help deal with the non-stationarity of the distribution of visited states of the environment as the system learns, by reducing the effect of stale cluster centers in the memory. That is, clusters that do not have observations assigned to them for a long time are eventually replaced. This is particularly useful if the memory is not reset after every episode.

The memory 140 can be initialized so that it has no stored state embedding cluster centers, e.g. it may be initialized to zero. In some implementations the memory 140 is never reset, i.e. it is maintained, not reset, between episodes. Here an “episode” is a series of interactions of the agent with the environment during which the agent attempts to perform a particular task. An episode may end with a terminal state indicating whether or not the task was performed, or after a specified number of action-selection time steps. The described techniques facilitate not resetting the memory between episodes, and enable the memory 140 to maintain relevant state embedding cluster centers over long timescales, potentially thousands of episodes, which can result in better exploration.

In some implementations the task of the agent is to explore the states of the environment, and in these implementations the reward may consist of the intrinsic reward, i.e. no further reward may be needed. In some implementations the agent learns to perform a task in addition to the task of exploring the states of the environment. Thus some implementations of the method include obtaining an extrinsic or task reward after the agent performs the selected action. The extrinsic or task reward characterizes progress of the agent towards accomplishing a particular task (the additional task), and the reward i.e. an overall reward, can be determined from a combination of the intrinsic reward and the (extrinsic) task reward.

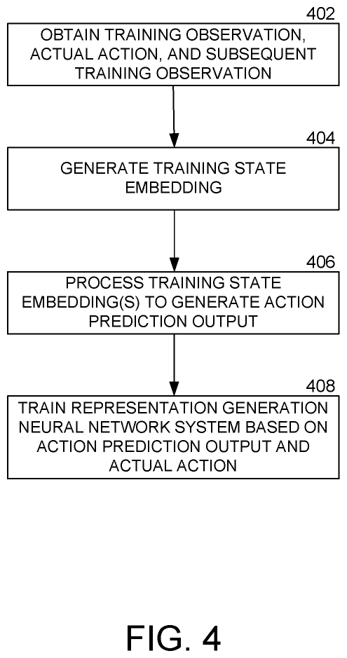

FIG. 4 is a flow diagram of an example process for training a representation generation neural network system, e.g. the representation generation neural network system 130 of FIG. 1. The process of FIG. 4 may be implemented by one or more computers in one or more locations, e.g. by the training engine 150, and can enable the representation generation neural network system to provide state embeddings that are particularly useful for the processes of FIGS. 2 and 3.

The process involves obtaining, for at least one time step, a training observation at the time step, an actual action performed at the time step, and a subsequent training observation at a next time step (step 402). These data may be obtained at the same time steps as the agent acts in the environment, or from a replay buffer where they were previously stored.

Each of the training observations can then be processed using the representation generation neural network system 130, and in accordance with the representation generation neural network parameters, to generate a respective training state embedding for each of the training observations (step 404).

Each of the training state embeddings can then be processed, one at a time or jointly, using an action prediction neural network system, and in accordance with action prediction neural network parameters, to generate an action prediction output (step 406). The action prediction output may define a probability distribution over actions. As one example, the training state embeddings may be provided to a MLP (Multi-Layer Perceptron) e.g. with a softmax output layer.

The representation generation neural network system and the action prediction neural network system may then be trained based on the action prediction output and the actual action (step 408). For example the system may be trained using a maximum likelihood loss, adjusting the parameters of the systems by backpropagating gradients of the loss.

As a particular example, the action prediction neural network system may comprise a classifier neural network, g(·), that, given the embeddings of the training observation, oₜ, and the subsequent training observation, oₜ₊₁, f(oₜ) and f(oₜ₊₁) respectively (where f(·) denotes the embedding function implemented by the representation generation neural network system 130), outputs an estimate p(aₜ|oₜ, oₜ₊₁) of the probability of taking an action at. The classifier neural network learns to predict which action was taken between two observations so if, for example, a feature changes between these two observations regardless of the action taken it will not be useful for the prediction task. The classifier neural network, g(·), and the representation generation neural network system 130, f(·), are jointly trained by minimizing an expectation of the negative log likelihood −ln(p(aₜ|oₜ, oₜ₊₁)) where aₜ is the actual action performed at the time step.

In the example process described above the representation generation neural network system 130 sees the observations at two successive time steps and the action prediction neural network system is trained to predict the action in between, based on the state embeddings from the representation generation neural network system. This encourages the state embeddings to focus on controllable features in the environment rather than on extraneous but nonetheless novel features such as a clock on the wall or (a canonical example) a “noisy TV”. States that only differ in the noisy, uncontrollable part of the observation tend to be aliased together, so that the effect of the noise on exploration is mitigated. That is, using this approach the state embeddings are able to define a more meaningful notion of similarity, which is important when counting how many times similar states are visited.

Nonetheless this approach may still allow the learned state embeddings to focus on localized or low-level features. Requiring the representation generation neural network system 130 and action prediction neural network system to predict actions between observations over longer time intervals could in principle help, but there can be many different sequences of actions in between such observations.

In some implementations this is addressed by training using a sequence of multiple actions and allowing the action prediction neural network system to see (apart from the masking discussed below) all the actions except for a final action of the sequence.

This may comprise obtaining the training observation at the time step, the actual action performed at the time step, and the subsequent training observation at the next time step, for each of a sequence of time steps. In the sequence of time steps the subsequent training observation at a time step is the training observation at the next time step.

Each of the (three or more) training observations in the sequence of time steps may then processed using the representation generation neural network system 130 to generate a respective training state embedding.

Each of the training state embeddings, and each of the actual actions in the sequence of time steps except for the final actual action in the sequence, may then be processed using the action prediction neural network system, to generate the action prediction output.

The representation generation neural network system and the action prediction neural network system may then be trained based on the action prediction output and the final actual action.

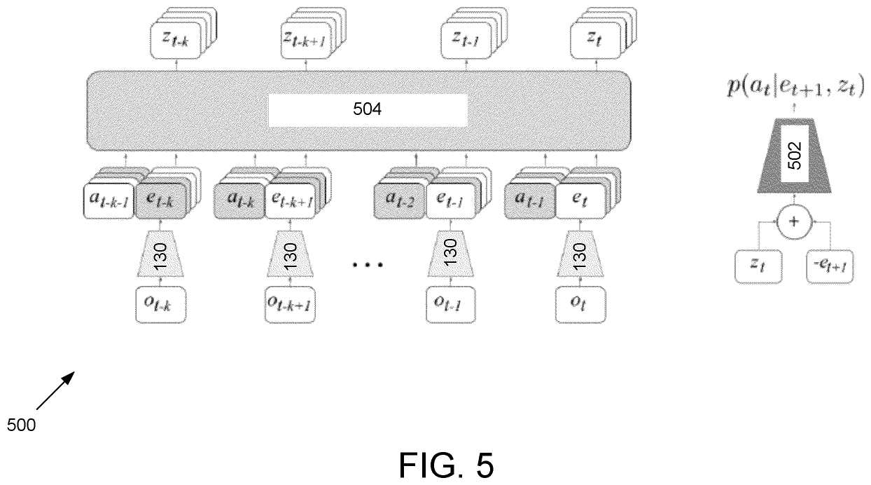

FIG. 5 shows an example action prediction neural network system 500 that can be used for jointly training the representation generation neural network system 130, f(·), and an action prediction neural network 502 using a sequence of actions. The training can be performed at the same time as training the action selection neural network system 120, or separately from training the action selection neural network system 120.

In FIG. 5 the action prediction neural network system 500 includes a transformer neural network 504. In general a transformer neural network may be a neural network characterized by having a succession of self-attention neural network layers. A self-attention neural network layer has an attention layer input for each element of the input and is configured to apply an attention mechanism over the attention layer input to generate an attention layer output for each element of the input. There are many different attention mechanisms that may be used.

The transformer neural network 504 of FIG. 5 takes an input sequence of length k comprising actions di, e.g. as action embeddings, and training state embeddings eᵢ=f(oᵢ) leading up to the observation at the current time step, oₜ, and generates a transformer neural network output, zₜ. The transformer neural network output, zₜ, and the state embedding for the next time step, eₜ₊₁, can be provided to the action prediction neural network 502, e.g. a 1-step action prediction classifier as previously described, to predict the probability of taking the actual action at, p(at |oₜ, oₜ₊₁). Thus the system can predict the probability of taking an action at given the observation oₜ, and a sequence of observations leading up to oₜ, and the subsequent observation, oₜ₊₁. In some implementations the transformer neural network output zₜ can be projected down to the size (dimension) of the embedding eₜ₊₁ (if necessary) and, as illustrated, a difference between the two can provide an input to a classifier neural network.

The transformer neural network may be masked, e.g. so that at each time step one of either f(oₜ) or aₜ is randomly substituted with a mask token to provide masked inputs (shown shaded in FIG. 5) that are then provided as an input to the transformer neural network. The mask token can be any arbitrary input that indicates missing information. Multiple different mask tokens, e.g. 4 different mask tokens, may be randomly sampled per input sequence. The masking encourages the action prediction neural network system to learn to infer the missing information from f(oₜ), given the inputs for previous time steps, so that the representation generation neural network system 130 is further encouraged to build embeddings that capture higher level information about the environment.

In some implementations (not explicitly shown in FIG. 5) the system 500 can also include an action embedding neural network system, configured to process an action to generate an action embedding. Then each of the actual actions in the sequence of time steps except the final actual action can be processed using the action embedding neural network system, to generate a respective action embedding.

The transformer neural network can then process the training state embedding for the time step and the action embedding of the actual action for successive time steps (except for the final actual action), to generate the transformer neural network output. For example, each of the training state embeddings and each of the action embeddings may define a respective token, and these tokens may be processed (in parallel) by the transformer neural network to generate the transformer neural network output. The transformer neural network output and the subsequent state embedding may then be processed to generate the action prediction output, in particular so that the representation generation neural network system 130 and the action prediction neural network system 500 may then be trained based on the action prediction output and the final actual action as previously described.

Again as previously described, the transformer neural network output may have, or

may be projected to, a vector of the same dimension as one of the state embeddings, and this may then be processed using the action prediction neural network system to predict the final actual action. This can involve determining a difference between the (projected) transformer neural network output and the training state embedding of a final observation in the sequence of time steps. This may then be processed e.g. by an MLP e.g. with a final softmax layer, to predict the final actual action.

The above described techniques for training the representation generation neural network system 130 to generate useful representations may be used independently of the exploration techniques described herein.

An exploration process similar to that described above can be implemented without the memory 140, e.g. based on training the representation generation neural network system 130 as described above, e.g. with reference to FIG. 5. Such a process can include generating an intrinsic reward to reward exploration of the environment by the agent, and using the subsequent state embedding to evaluate the subsequent state of the environment, in particular to evaluate a relative novelty of the subsequent state of the environment, e.g. as compared with previously visited states of the environment. The action selection neural network system 120 may be trained based on the intrinsic reward, e.g. by updating the values of the training action selection neural network parameters based on the intrinsic reward. Generating the intrinsic reward may comprise obtaining and processing a sequence of training observations and actions as previously described.

In some implementations of the systems and methods described above the action selection neural network system comprises a learner action selection neural network and one or more actor action selection neural networks. Each of these may comprise an instance of the action selection neural network system 120, and optionally also an instance of the representation generation neural network system 130. Processing the current observation, using the action selection neural network system and in accordance with the action selection neural network parameters, to select an action to be performed by the agent at the time step may then comprise processing the current observation using the actor action selection neural network system in accordance with action selection neural network parameters provided by the learner action selection neural network. That is, the one or more actor action selection neural network systems may periodically obtain a set of parameters from the learner action selection neural network.

Such a system may include a replay buffer storing data representing, for each time step, the current observation, the selected action, the (overall) reward and/or the intrinsic reward, and the subsequent observation. In some implementations these data may be maintained in the replay buffer for each of the one or more actor action selection neural network systems. The values of the action selection neural network parameters may be updated using the data stored in the replay buffer, e.g. by training the learner action selection neural network using the data stored in the replay buffer, e.g. using an off-policy reinforcement learning technique, such as Q-learning.

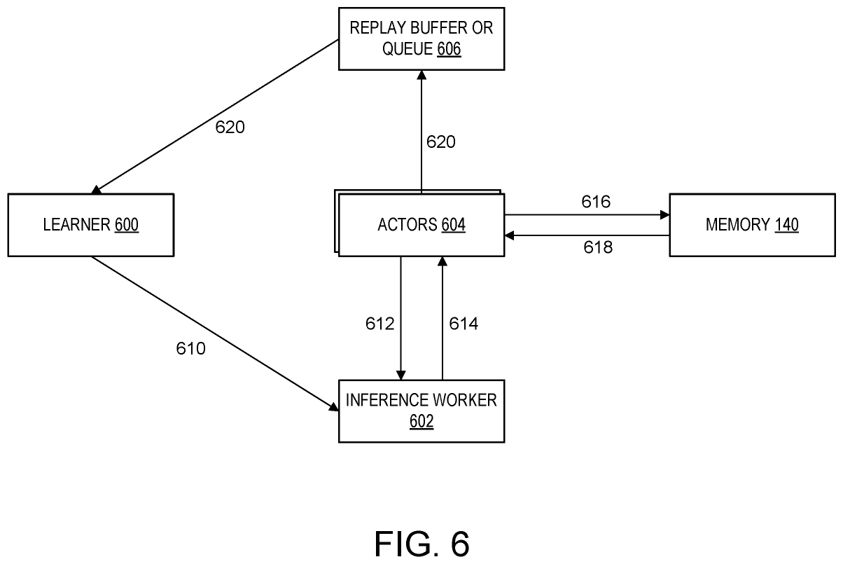

FIG. 6 is a block diagram of an example of a reinforcement learning neural network system 600 that is an implementation of the computer-implemented neural network system 100 in a parallel, distributed computing system.

The system 600 includes a learner 600, i.e. a learner action selection neural network, and an inference worker 602, i.e. an actor action selection neural network. In practice the learner 600 and the inference worker 602 may each comprise an instance of the action selection neural network system 120, and optionally also an instance of the representation generation neural network system 130. The system includes multiple independent actors 604 and an implementation of the memory 140. Optionally the system 600 may include a repay buffer or data queue 606. The system 600 performs operations in parallel as described below.

The learner 600 operates to train its action selection neural network system and optionally also its representation generation neural network system, i.e. to update its action selection neural network parameters, and optionally also its representation generation neural network system parameters, as previously described. The action selection neural network parameters 610 are provided from the learner 600 to the inference worker 602. In implementations, the representation generation neural network system parameters are also provided from the learner 600 to the inference worker 602.

The learner 600 trains its action selection neural network system 120 using transitions 620 received from the actors 604, either directly or via the replay buffer or data queue 606. Each transition 620 comprises at least an observation at a time step, the action taken at the time step, an observation at the next time step, and a reward. The learner 600 can also train its representation generation neural network system 130 using the transitions 620.

The inference worker 602 selects actions for each of the actors using the action selection neural network system, configured with the action selection neural network parameters received from the learner 600. The inference worker 602 receives a history of one or more observations including a current observation from an actor 604, and processes the history of observations using its instance of the action selection neural network system 120, to select an action for the actor. In implementations the inference worker 602 also processes the history of observations using its instance of the representation generation neural network system 130, configured with the representation generation neural network system parameters received from the learner 600, to generate an embedding of the history of observations of the actor. The inference worker 602 does this for each of the actors 604, and at each time step t.

The history of observations may comprise just the current observation from the actor at time step t, or it may also include one or more observations preceding the current observation.

Each of the actors 604 acts in the environment with a respective agent. That is, in implementations each actor may act in a respective copy or version of the environment using its respective agent. Each of the actors 604 queries the inference worker 602 with a history of observations of the actor including the current observation and receives, in response, an action for the actor to execute (using its agent) in its respective environment, and an embedding of the history of observations of the actor.

Each of the actors 604 provides the embedding of the history of observations of the actor (at each time step) to the memory 140 and receives, in response, an intrinsic reward. The intrinsic reward is added to an extrinsic (task) reward to provide the reward for the transition that is provided to the learner 600.

In implementations the memory 140 is shared across (between) all the actors 604. It has been found that when the memory stores records of previously visited regions of state space of the environment as data comprising state embedding cluster centers as described above, collecting records from all the actors and storing them in the same shared memory does not result in interference within the memory. Further, using such a shared memory can improve the learning performance because the memory of one actor can benefit from information collected by another actor. These benefits are further enhanced where, as in some implementations, the shared memory is maintained, i.e. not reset, between episodes.

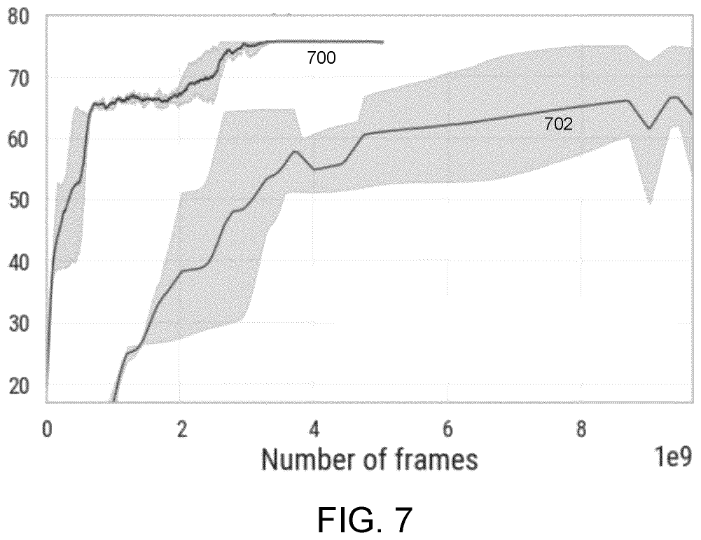

FIG. 7 illustrates the performance of an example implementation of the neural network system 100 as described above (curve 700), with the representation generation neural network system 130 trained as described with reference to FIG. 5. FIG. 7 illustrates the system learning to perform a task in a difficult 3D, partially observable, continuous action environment. The y-axis shows performance (in arbitrary units); the x-axis shows environment time steps. The performance is compared with that of a state-of-the-art system learning to perform the same task (curve 702).

For illustrative purposes a few of the tasks that the computer neural network system 100 can perform now described.

As one example the environment may be a real-world environment, the agent may be a mechanical agent, and the action selection neural network system may be used to select actions to be performed by the mechanical agent in response to observations obtained from one or more sensors sensing the real-world environment, to control the agent, e.g. to perform the (additional) task while interacting with the real-world environment. The (additional) task may be to move the agent or a part of the agent, e.g. to navigate in the environment and/or to move a part of the agent such as a robot arm e.g. to move or manipulate the agent or an object in three dimensions.

In some implementations the action selection neural network system may be trained using a reinforcement learning technique based on a combination of the intrinsic reward and an estimate of a “return”, a cumulative measure of the task reward received by the system as the agent interacts with the environment over multiple time steps, such as a time-discounted reward received by the system.

As mentioned, in some implementations the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the mechanical agent, e.g. robot, may be interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a The manufacturing plant may comprise a plurality of cleaned or recycled product. manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The (task) rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The (task) rewards or return may relate to a metric of performance of the task. For example in the case of a task to control, e.g. minimize, use of a resource, such as a task to control use of electrical power or water, the metric may comprise any metric of use of the resource.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The (task) rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such observations may thus include observations of wind levels or solar irradiance, or of local time, date, or season. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that indirectly performs or controls the protein folding actions, e.g. by controlling chemical synthesis steps selected by the system automatically without human interaction. The observations may comprise direct or indirect observations of a state of the protein or chemical/intermediates/precursors and/or may be derived from simulation. Thus the system may be used to automatically synthesize a protein with a particular function such as having a binding site shape, e.g. a ligand that binds with sufficient affinity for a biological effect that it can be used as a drug. For example e.g. it may be an agonist or antagonist of a receptor or enzyme; or it may be an antibody configured to bind to an antibody target such as a virus coat protein, or a protein expressed on a cancer ce∥, e.g. to act as an agonist for a particular receptor or to prevent binding of another ligand and hence prevent activation of a relevant biological pathway.

In a similar way the environment may be a drug design environment such that each state is a respective state of a potential pharmaceutically active compound, i.e. a drug, and the agent is a computer system for determining elements of the pharmaceutically active compound and/or a synthetic pathway for the pharmaceutically active compound. The drug/synthesis may be designed based on a (task) reward derived from a target for the pharmaceutically active compound, for example in simulation. The agent may be, or may include, a mechanical agent that performs or controls synthesis of the pharmaceutically active compound; and hence a process as described herein may include making such a pharmaceutically active compound.

In some applications the agent may be a software agent i.e. a computer program, configured to perform a task. For example the environment may be a circuit or an integrated circuit design or routing environment and the agent may be configured to perform a design or routing task for routing interconnection lines of a circuit or of an integrated circuit e.g. an ASIC. The (task) reward(s) may then be dependent on one or more routing metrics such as interconnect length, resistance, capacitance, impedance, loss, speed or propagation delay; and/or physical line parameters such as width, thickness or geometry, and design rules. The (task) reward(s) may also or instead include one or more (task) reward(s) relating to a global property of the routed circuitry e.g. component density, operating speed, power consumption, material usage, a cooling requirement, level of electromagnetic emissions, and so forth. The observations may be e.g. observations of component positions and interconnections; the actions may comprise component placing actions e.g. to define a component position or orientation and/or interconnect routing actions e.g. interconnect selection and/or placement actions. The method may include making the circuit or integrated circuit to the design, or with interconnection lines routed as determined by the method.

In some applications the agent is a software agent and the environment is a real-world computing environment. In one example the agent manages distribution of tasks across computing resources e.g. on a mobile device and/or in a data center. In these applications, the observations may include observations of computing resources such as compute and/or memory capacity, or Internet-accessible resources; and the actions may include assigning tasks to particular computing resources. The (task) reward(s) may be configured to maximize or minimize one or more of: utilization of computing resources, electrical power, bandwidth, and computation speed.

In another example the software agent manages the processing, e.g. by one or more real-world servers, of a queue of continuously arriving jobs. The observations may comprise observations of the times of departures of successive jobs, or the time intervals between the departures of successive jobs, or the time a server takes to process each job, e.g. the start and end of a range of times, or the arrival times, or time intervals between the arrivals, of successive jobs, or data characterizing the type of job(s). The actions may comprise actions that allocate particular jobs to particular computing resources; the (task) reward(s) may be configured to minimize an overall queueing or processing time or the queueing or processing time for one or more individual jobs, or in general to optimize any metric based on the observations.

As another example the environment may comprise a real-world computer system or network, the observations may comprise any observations characterizing operation of the computer system or network, the actions performed by the software agent may comprise actions to control the operation e.g. to limit or correct abnormal or undesired operation e.g. because of the presence of a virus or other security breach, and the (task) reward(s) may comprise any metric(s) that characterizing desired operation of the computer system or network.

In some applications, the environment is a real-world computing environment and the software agent manages distribution of tasks/jobs across computing resources e.g. on a mobile device and/or in a data center. In these implementations, the observations may comprise observations that relate to the operation of the computing resources in processing the tasks/jobs, the actions may include assigning tasks/jobs to particular computing resources, and the (task) reward(s) may relate to one or more metrics of processing the tasks/jobs using the computing resources, e.g. metrics of usage of computational resources, bandwidth, or electrical power, or metrics of processing time, or numerical accuracy, or one or more metrics that relate to a desired load balancing between the computing resources.

In some applications the environment is a data packet communications network environment, and the agent is part of a router to route packets of data over the communications network. The actions may comprise data packet routing actions and the observations may comprise e.g. observations of a routing table which includes routing metrics such as a metric of routing path length, bandwidth, load, hop count, path cost, delay, maximum transmission unit (MTU), and reliability. The (task) reward(s) may be defined in relation to one or more of the routing metrics i.e. configured to maximize one or more of the routing metrics.

In some other applications the environment is an Internet or mobile communications environment and the agent is a software agent which manages a personalized recommendation for a user. The observations may comprise previous actions taken by the user, e.g. features characterizing these; the actions may include actions recommending items such as content items to a user. The (task) reward(s) may be configured to maximize one or more of: an estimated likelihood that the user will respond favorably to being recommended the (content) item, a suitability unsuitability of one or more recommended items, a cost of the recommended item(s), and a number of recommendations received by the user, optionally within a time span.

As a further example, the actions may include presenting advertisements, the observations may include advertisement impressions or a click-through count or rate, and the (task) reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The (task) rewards or return may comprise one or more metric of performance of the design of the entity. For example (task) rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus the design of an entity may be optimized, e.g. by reinforcement learning, and then the optimized design output for manufacturing the entity, e.g. as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the (task) reward received at the previous time step, or both.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are correspond toed in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of training a computer-implemented neural network system used to control an agent interacting with an environment, wherein the computer-implemented neural network system comprises: an action selection neural network system used to select actions to be performed by the agent, a representation generation neural network system configured to process an observation of a state of the environment to generate a state embedding, and episodic memory; the method comprising, at a plurality of time steps:
obtaining a current observation characterizing a current state of the environment;
processing the current observation using the action selection neural network system to select an action to be performed by the agent at the time step;
obtaining a subsequent observation characterizing a subsequent state of the environment after the agent performs the selected action;
processing the subsequent observation using the representation generation neural network system to generate a subsequent state embedding representing at least the subsequent observation; and
performing an update step on data stored in the episodic memory using the subsequent state embedding; the method further comprising:
maintaining in the episodic memory a record of previously visited regions of a state space of the environment as data comprising state embedding cluster centers representing centers of the previously visited regions in a space of the state embeddings, and for each state embedding cluster center a corresponding count value representing a visitation count of the corresponding region of state space of the environment by the agent;
generating an intrinsic reward, using the state embedding cluster center and corresponding count value data stored in the episodic memory, to reward exploration of states of the environment by the agent; and
training the action selection neural network system based on a reward including the intrinsic reward; and wherein performing the update step comprises:
updating or replacing one or more of the state embedding cluster centers and one or more of the corresponding count values using the subsequent state embedding.

2. The method of claim 1, wherein performing the update step comprises:
determining whether to perform an update or replacement of one or more existing state embedding cluster centers stored in the episodic memory, based on a distance of the subsequent state embedding from a nearest existing state embedding cluster center, and
when the subsequent state embedding is within a threshold distance of the nearest existing state embedding cluster center, updating the nearest existing state embedding cluster center and the corresponding count value, and
when the subsequent state embedding is beyond a threshold distance of the nearest existing state embedding cluster center, replacing an underpopulated existing state embedding cluster center.

3. The method of claim 1, or 2, wherein the episodic memory is configured to store, in each of a plurality of indexed locations, data comprising a state embedding cluster center and a corresponding count value, the method further comprising:
selecting one of the indexed locations as the indexed location of a state embedding cluster center to remove from the episodic memory, and selecting a corresponding count value, in response to a distance between the subsequent state embedding and a nearest one of the state embedding cluster centers stored in the episodic memory being greater than a threshold distance;
replacing the state embedding cluster center at the indexed location in the episodic memory with the subsequent state embedding and redistributing the selected corresponding count value over one or more other indexed locations in the episodic memory; and
initializing the corresponding count value for the replaced state embedding cluster center.

4. The method of claim 3, comprising:
determining, according to a distance metric, the distance between the subsequent state embedding and the nearest one of the state embedding cluster centers stored in the episodic memory according to the distance metric;
determining whether the distance satisfies a distance condition, wherein the distance condition is satisfied when the distance is greater than the threshold distance; and
selecting the indexed location of the state embedding cluster center to remove from the episodic memory and the corresponding count value in response to the distance condition being satisfied.

5. The method of claim 4, further comprising performing the selecting subject to a selection probability.

6. The method of claim 3, wherein selecting one of the indexed locations as the indexed location of the state embedding cluster center to remove from the episodic memory comprises:
selecting the indexed location of the state embedding cluster center according to the corresponding count of the state embedding cluster center, with a bias towards selecting the indexed location with a relatively lower corresponding count value.

7. The method of claim 3, wherein the selecting comprises:
sampling the indexed location of the state embedding cluster center to remove according to a probability that depends inversely on the corresponding count value.

8. The method of claim 3, wherein performing the update step further comprises, in response to the distance between the subsequent state embedding and the nearest one of the state embedding cluster centers stored in the episodic memory not being greater than the threshold distance:
updating the state embedding cluster center at the nearest one of the state embedding cluster centers using the subsequent state embedding; and
updating the corresponding count value for the nearest one of the state embedding cluster centers.

9. The method of claim 8, wherein updating the state embedding cluster center at the nearest one of the state embedding cluster centers using the subsequent state embedding comprises:
determining an updated value of the state embedding cluster center as a linear combination of: a current value of the state embedding cluster center weighted by the corresponding count value, and the subsequent state embedding.

10. The method of claim 3, wherein performing the update step further comprises updating the threshold distance based on the distance between the subsequent state embedding and at least the nearest one of the state embedding cluster centers stored in the episodic memory.

11. The method of claim 3, wherein redistributing the selected corresponding count value over one or more other indexed locations in the episodic memory comprises adding the selected corresponding count value to the corresponding count value for a nearest one of the state embedding cluster centers to the replaced state embedding cluster center.

12. The method of claim 1, wherein generating the intrinsic reward using the data stored in the episodic memory comprises:
determining a measure of a similarity between the subsequent state embedding and one or more of the state embedding cluster centers; and
determining the intrinsic reward as a value that depends inversely on both the measure of the similarity and the corresponding count values for the one or more state embedding cluster centers.

13. The method of claim 1, wherein generating the intrinsic reward using the data stored in the episodic memory comprises:
determining a soft visitation count for the subsequent state embedding from a combination of count values weighted by kernel functions, wherein each kernel function depends on a similarity between the subsequent state embedding and a respective one of the state embedding cluster centers, and wherein each kernel function weights a corresponding count value for the respective one of the state embedding cluster centers in the combination; and
determining the intrinsic reward as an intrinsic reward function of the soft visitation count, wherein the intrinsic reward function has a value that decreases as the soft visitation count increases.

14. The method of claim 1, wherein performing the update step further comprises decaying each of the corresponding count values stored in the episodic memory.

15. The method of claim 1, further comprising training the representation generation neural network system by:
obtaining, for at least one time step, a training observation at the time step, an actual action performed at the time step, and a subsequent training observation at a next time step;
processing each of the training observations using the representation generation neural network system, to generate a respective training state embedding for each of the training observations;
processing each of the training state embeddings using an action prediction neural network system, to generate an action prediction output;
training the representation generation neural network system and the action prediction neural network system based on the action prediction output and the actual action.

16. The method of claim 15, comprising:
obtaining the training observation at the time step, the actual action performed at the time step, and the subsequent training observation at the next time step, for each of a sequence of time steps;
processing each of the training observations in the sequence of time steps using the representation generation neural network system to generate a respective training state embedding for each of the training observations in the sequence of time steps;
processing i) each of the training state embeddings, and ii) each of the actual actions in the sequence of time steps except a final actual action in the sequence of time steps, using the action prediction neural network system, to generate the action prediction output; and
training the representation generation neural network system and the action prediction neural network system based on the action prediction output and the final actual action.

17. The method of claim 16, further comprising:
processing each of the actual actions in the sequence of time steps except the final actual action in the sequence of time steps using an action embedding neural network system, to generate a respective action embedding;
wherein the action prediction neural network system includes a transformer neural network, and wherein processing each of the training state embeddings and each of the actual actions in the sequence of time steps except the final actual action, using the action prediction neural network system, comprises:
processing, for successive time steps of the sequence of time steps, the training state embedding for the time step and the action embedding of the actual action for the time step, using the transformer neural network, to generate a transformer neural network output; and
processing the transformer neural network output and the subsequent state embedding to generate the action prediction output.

18. The method of claim 1, implemented in a parallel distributed reinforcement learning computing system including multiple independent actors, each actor acting in parallel in the environment with a respective agent; the method further comprising sharing the episodic memory between all the actors; and wherein the memory is maintained between episodes.

19. (canceled)

20. (canceled)

21. (canceled)

22. (canceled)

23. (canceled)

24. (canceled)

25. (canceled)

26. (canceled)

27. (canceled)

28. One or more computer storage media storing instructions that when executed by one or more computers cause the one or more computers to operations for training a computer-implemented neural network system used to control an agent interacting with an environment, wherein the computer-implemented neural network system comprises: an action selection neural network system used to select actions to be performed by the agent, a representation generation neural network system configured to process an observation of a state of the environment to generate a state embedding, and episodic memory;
the operations comprising, at a plurality of time steps:
obtaining a current observation characterizing a current state of the environment;
processing the current observation using the action selection neural network system to select an action to be performed by the agent at the time step;
obtaining a subsequent observation characterizing a subsequent state of the environment after the agent performs the selected action;
processing the subsequent observation using the representation generation neural network system to generate a subsequent state embedding representing at least the subsequent observation; and
performing an update step on data stored in the episodic memory using the subsequent state embedding; the method further comprising:
maintaining in the episodic memory a record of previously visited regions of a state space of the environment as data comprising state embedding cluster centers representing centers of the previously visited regions in a space of the state embeddings, and for each state embedding cluster center a corresponding count value representing a visitation count of the corresponding region of state space of the environment by the agent;
generating an intrinsic reward, using the state embedding cluster center and corresponding count value data stored in the episodic memory, to reward exploration of states of the environment by the agent; and
training the action selection neural network system based on a reward including the intrinsic reward; and wherein performing the update step comprises:
updating or replacing one or more of the state embedding cluster centers and one or more of the corresponding count values using the subsequent state embedding.

29. A system comprising:
one or more computers; and
one or more storage devices communicatively coupled to the one or more computers, wherein the one or more storage devices store instructions that, when executed by the one or more computers, cause the one or more computers to perform operations for training a computer-implemented neural network system used to control an agent interacting with an environment, wherein the computer-implemented neural network system comprises: an action selection neural network system used to select actions to be performed by the agent, a representation generation neural network system configured to process an observation of a state of the environment to generate a state embedding, and episodic memory;
the operations comprising, at a plurality of time steps:
obtaining a current observation characterizing a current state of the environment;
processing the current observation using the action selection neural network system to select an action to be performed by the agent at the time step;
obtaining a subsequent observation characterizing a subsequent state of the environment after the agent performs the selected action;
processing the subsequent observation using the representation generation neural network system to generate a subsequent state embedding representing at least the subsequent observation; and
performing an update step on data stored in the episodic memory using the subsequent state embedding; the method further comprising:
maintaining in the episodic memory a record of previously visited regions of a state space of the environment as data comprising state embedding cluster centers representing centers of the previously visited regions in a space of the state embeddings, and for each state embedding cluster center a corresponding count value representing a visitation count of the corresponding region of state space of the environment by the agent;
generating an intrinsic reward, using the state embedding cluster center and corresponding count value data stored in the episodic memory, to reward exploration of states of the environment by the agent; and
training the action selection neural network system based on a reward including the intrinsic reward; and wherein performing the update step comprises:
updating or replacing one or more of the state embedding cluster centers and one or more of the corresponding count values using the subsequent state embedding.
